(19) United States
(12) Patent Application Publication
(10) Pub. No.: US 2018/0112810 A1
(43) Pub. Date: Apr. 26, 2018

(54) LEAK PREVENTION DEVICE AND METHOD

(71) Applicants: Eduardo Rodriguez, North Little Rock, AR (US); Elizabeth Rodriguez, North Little Rock, AR (US)

(72) Inventors: Eduardo Rodriguez, North Little Rock, AR (US); Elizabeth Rodriguez, North Little Rock, AR (US)

(21) Appl. No.: 15/795,142

(22) Filed: Oct. 26, 2017

Related U.S. Application Data
(60) Provisional application No. 62/412,845, filed on Oct. 26, 2016.

(51) Int. Cl. F16L 55/115; F16L 37/12; F16L 25/12

(52) U.S. Cl. CPC F16L 55/1157; F16L 55/1715; F16L 25/12; F16L 37/12

(57) ABSTRACT

A device for preventing leaks is disclosed herein. The device for preventing leaks includes a cylindrical body that may have a top end and a bottom end, a spring being biased within a hollow portion of the cylindrical body, a plurality of ball bearings located on an inner lower portion of the cylindrical body, a plurality of O-rings being removably located within the hollow portion of the cylindrical body, a sleeve being movably coupled to the cylindrical body, and wherein the device may be configured to prevent leakage from a pressurized valve.

### CROSS REFERENCE TO RELATED APPLICATION

The present application is related to and claims priority to U.S. Provisional Patent Application No. 62/412,845 filed Oct. 26, 2016, which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### 1. Field of the Invention

The present invention relates generally to the field of pipe joints or couplings and more specifically relates to cap closures.

### 2. Description of Related Art

Over time, a vehicle's air conditioning valve core can become damaged and leak Freon. Unfortunately, the coolant is toxic if absorbed into the ground or ingested by animals, causing widespread pollution and illness. Freon is a gas, and may damage the environment by depleting the ozone layer. Additionally, it can be expensive for drivers to not only replace the leaking coolant/Freon but also repair the damaged air conditioning.

U.S. Pat. No. 9,180,755 to Ronie Dale Durall relates to a service port adapter device. The described service port adapter device includes an adapter device with a PTFE gasket that stops vehicle air conditioning system leaks on most R134a refrigerant non-serviceable air conditioning hoses. The adapter device makes the hose serviceable by replacing the damage non-serviceable service port with a new serviceable service port and valve.

### BRIEF SUMMARY OF THE INVENTION

In view of the foregoing disadvantages inherent in the known pipe joints or couplings art, the present disclosure provides a novel leak prevention device and method. The general purpose of the present disclosure, which will be described subsequently in greater detail, is to provide a quick connection and securing system for a vehicle air conditioning high and low intake valve stem. The leak prevention device may be designed for tool-less installations. Once installed, the system may effectively eliminate air conditioning leaks by maintaining pressure in the valve stem of the air conditioning line which stops the most common type of leak, and in turn saves money by preventing coolant leaks into the atmosphere making the system environmentally friendly.

A device for preventing leaks is disclosed herein. The device for preventing leaks includes a cylindrical body that may have a top end and a bottom end, a spring being biased within a hollow portion of the cylindrical body, a plurality of ball bearings located on an inner lower portion of the cylindrical body, a plurality of O-rings being removably located within the hollow portion of the cylindrical body, a sleeve being movably coupled to the cylindrical body. As such the device may be configured to prevent leakage from a pressurized valve.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments for the present disclosure, a leak prevention device, constructed and operative according to the teachings of the present disclosure.

FIG. 1 is a front view of the device for preventing leaks during an ‘in-use’ condition, according to an embodiment of the disclosure.

FIG. 2 is a perspective view of the device for preventing leaks of FIG. 1, according to an embodiment of the present disclosure.

FIG. 3 is a bottom view of the device for preventing leaks of FIG. 1, according to an embodiment of the present disclosure.

FIG. 4 is a side view of the device for preventing leaks of FIG. 1, according to an embodiment of the present disclosure.

FIG. 5 is a side view of the device for preventing leaks of FIG. 1, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to pipe joints or couplings and more particularly to a leak prevention device to minimize negative environmental impact.

Generally, the leak prevention device stops a leak from the air conditioning fittings where the Freon is recharged. This replaces the little plastic caps that do not hold pressure at all, and allows the Freon to leak to the environment.

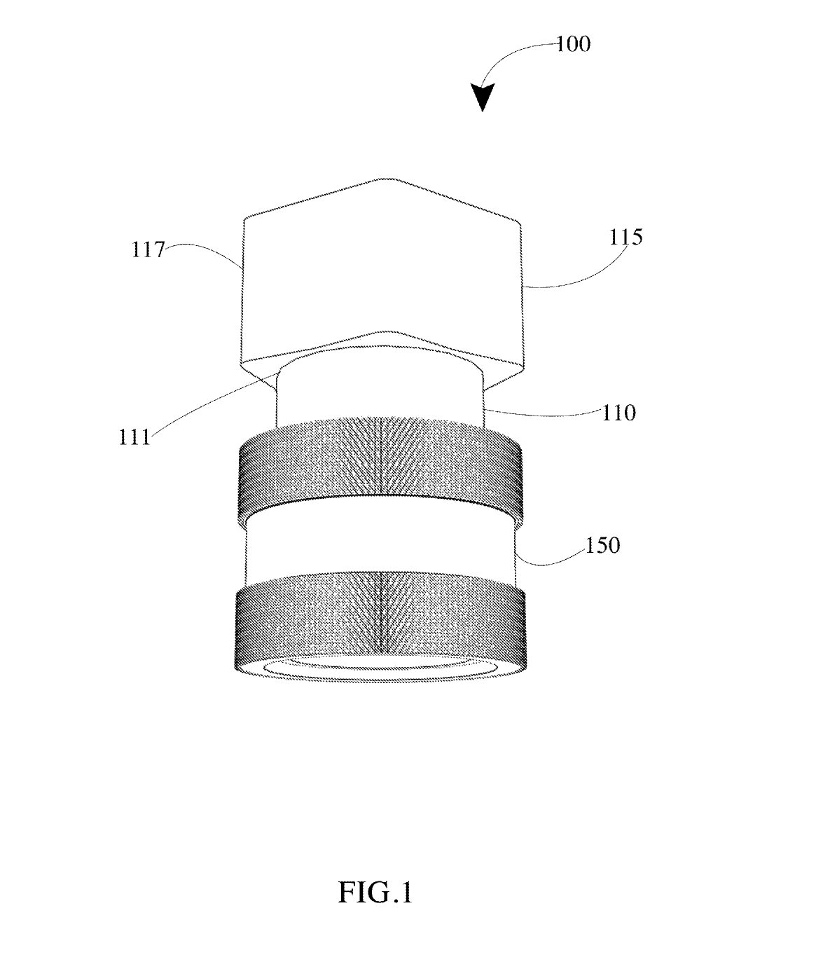

Referring now more specifically to the drawings by numerals of reference, there is shown in FIGS. 1-5, various views of a device for preventing leaks 100. FIG. 1 shows a device for preventing leaks 100 during an ‘in-use’ condition 50 by a user 40, according to an embodiment of the present disclosure. As illustrated, the device for preventing leaks 100 may include a cylindrical body 110, a spring 120, a plurality of ball bearings 130, a plurality of O-rings 140, and a sleeve 150. The cylindrical body 110 may have a top end 111 and a bottom end 112 and a hollow portion 113 which may house the spring 120. The cylindrical body 110 may even further have an inner-lower-portion 114 which may contain the plurality of ball bearings 130 for providing a ratcheting movement between an outer-lower-portion 116 of the cylindrical body 110. The cylindrical body 110 may have an outer-upper-portion-diameter 117 larger than an outer-lower-portion-diameter 118 so that the sleeve 150 may fit around the outer-lower-portion-diameter 118 and may move up the cylindrical body 110 until the sleeve 150 make contact with a hexagonal shape 119 of an outer-upper-portion 115 of the cylindrical body 110.

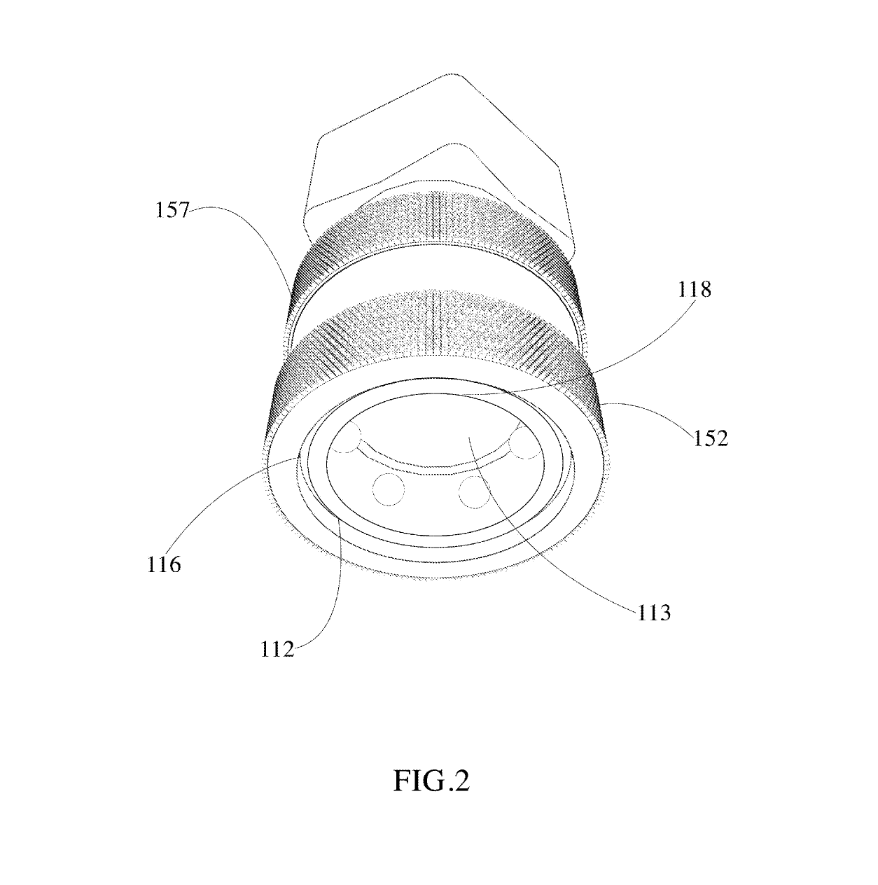

FIG. 2 shows a perspective view of the device for preventing leaks 100 of FIG. 1, according to an embodiment of the present disclosure. As above, the device for preventing leaks 100 may include the cylindrical body 110, the spring 120, the plurality of ball bearings 130, the plurality of O-rings 140, and the sleeve 150. The cylindrical body 110 may have an outer-upper-portion 115 that may have the hexagonal shape 119, and may be configured to provide a gripping means. The hollow portion 114 of the cylindrical body 110 may include a plurality of O-rings 140. The plurality of O-rings 140 may include at least 2 O-rings, which may provide a substantially airtight seal. The device for preventing leaks 100 may be designed to prevent leakage from a pressurized valve.

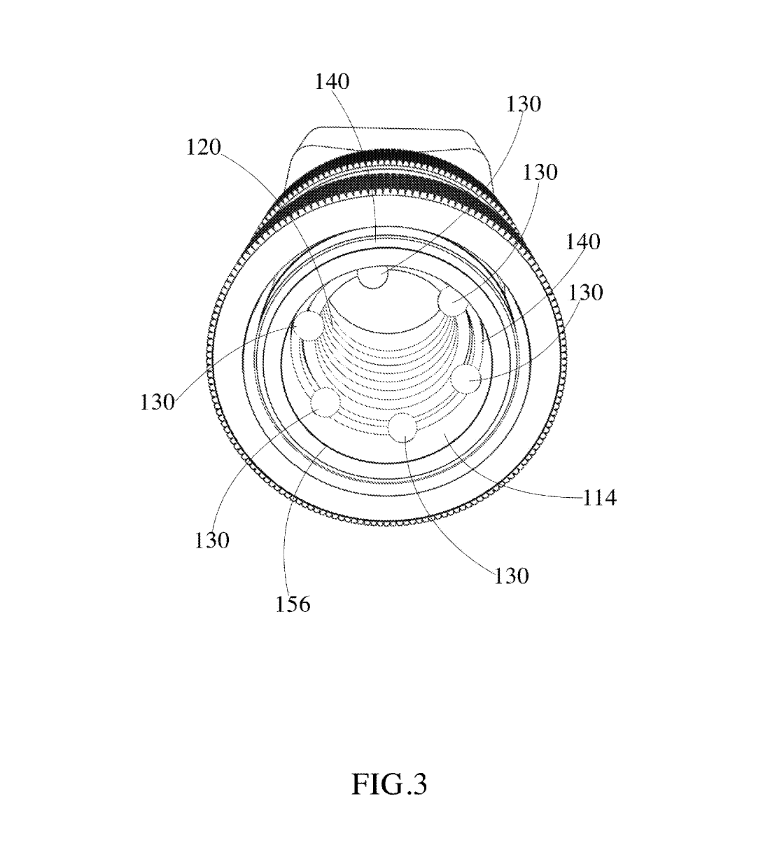

FIG. 3 shows a bottom view of the device for preventing leaks 100 of FIG. 1, according to an embodiment of the present disclosure. As above, the device for preventing leaks 100 may include the cylindrical body 110, the spring 120, the plurality of ball bearings 130, the plurality of O-rings 140, and the sleeve 150. The plurality of ball bearings 130 housed within the inner lower portion 114 of the cylindrical body 110 may include at least 2 ball bearings, which may be equally spaced apart about an inner circumference of the inner lower portion 114. The plurality of ball bearings 130 may be manufactured of an aluminum or other suitable material such as ceramic material or the like.

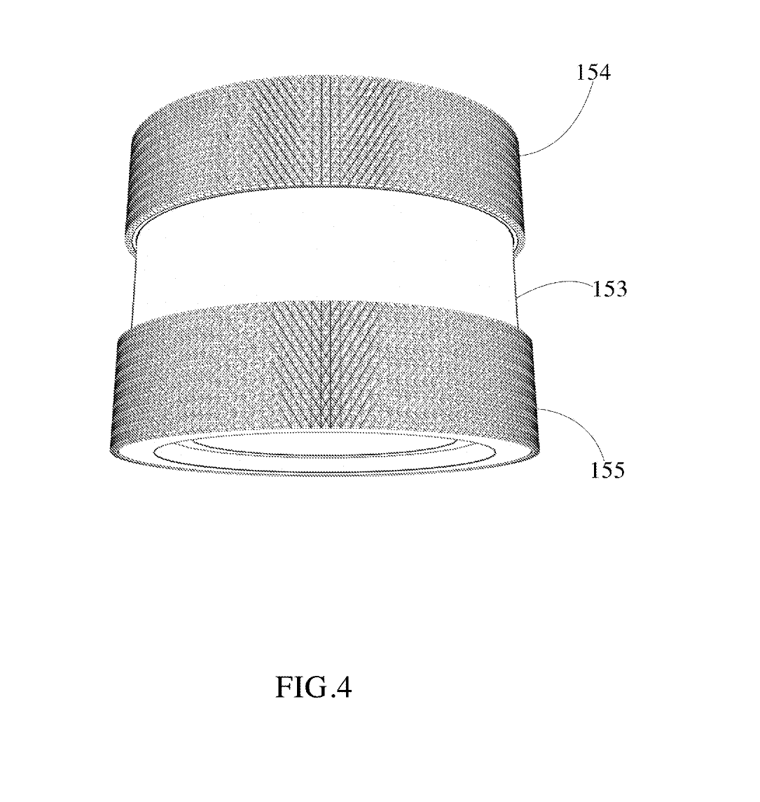

FIG. 4 shows a side view of the device for preventing leaks 100 of FIG. 1, according to an embodiment of the present disclosure. As above, the device for preventing leaks 100 may include the cylindrical body 110, the spring 120, the plurality of ball bearings 130, the plurality of O-rings 140, and the sleeve 150. The cylindrical body 110 may have an outer-upper-portion-diameter 117 larger than an outer-lower-portion-diameter 118 so that the sleeve 150 may fit around the outer-lower-portion-diameter 118 and may move up the cylindrical body 110 until the sleeve 150 contacts a hexagonal shape 119 of an outer-upper-portion 115 of the cylindrical body 110.

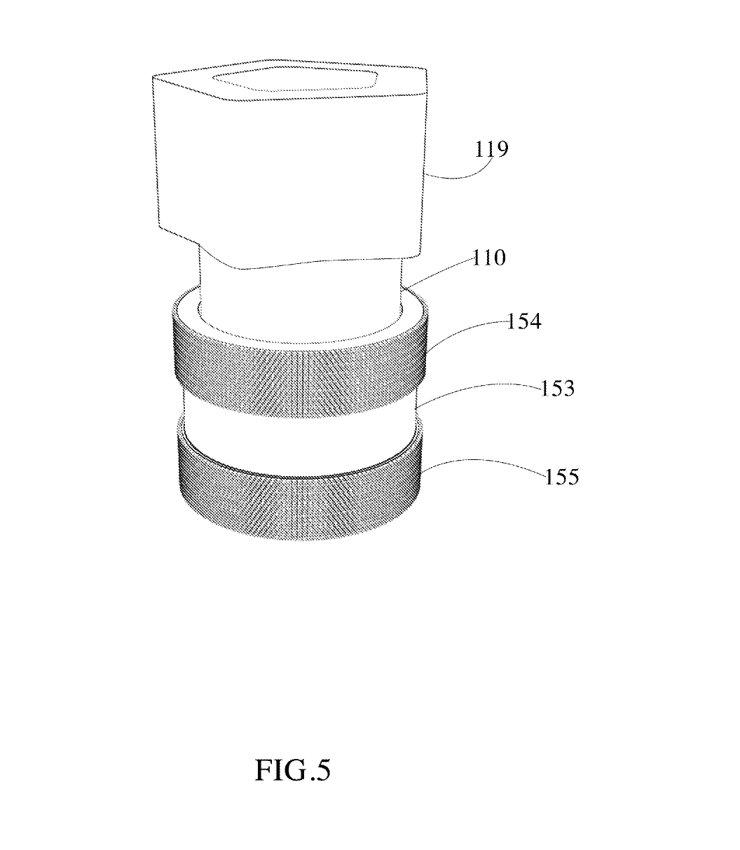

FIG. 5 shows a side view of the device for preventing leaks 100 of FIG. 1, according to an embodiment of the present disclosure. As above, the device for preventing leaks 100 may include the cylindrical body 110, the spring 120, the plurality of ball bearings 130, the plurality of O-rings 140, and the sleeve 150. The sleeve 150 of the device for preventing leaks 100 may have a top-portion-diameter 151 that may be greater than an outer-lower-portion-diameter 118 of said cylindrical body 110. The sleeve 150 of the device for preventing leaks 100 may further have a bottom-portion-diameter 152 greater than an outer-lower-portion-diameter 118 of said cylindrical body 110. The sleeve 150 of the device for preventing leaks 100 may even further include a middle portion 153 integrally connected to a top portion 154 and a bottom portion 155. The top portion 154 and the bottom portion 155 may include a rough texture 10, while the middle portion 153 of the sleeve 150 may have a smooth texture. The device may be retrofit to existing systems and used as such.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A device for preventing leaks, said device comprising:
a cylindrical body having a top end and a bottom end;
a spring, said spring being biased within a hollow portion of said cylindrical body;
a plurality of ball bearings, said plurality of ball bearings located on an inner lower portion of said cylindrical body;
a plurality of O-rings, said plurality of O-rings being removably located within said hollow portion of said cylindrical body; and
a sleeve, said sleeve being movably coupled to said cylindrical body; and
wherein said device is configured to prevent leakage from a pressurized valve.

2. The device for preventing leaks of claim 1, wherein said cylindrical body has an outer-upper-portion and an outer-lower-portion.

3. The device for preventing leaks of claim 2, wherein said outer-upper-portion has an outer-upper-portion-diameter larger than an outer-lower-portion-diameter.

4. The device for preventing leaks of claim 2, wherein said outer-upper-portion has a hexagonal profile.

5. The device for preventing leaks of claim 2, wherein said outer-upper-portion is configured to provide a gripping means.

6. The device for preventing leaks of claim 1, wherein said plurality of ball bearings comprise at least 2 of said ball bearings.

7. The device for preventing leaks of claim 1, wherein said plurality of ball bearings comprises aluminum.

8. The device for preventing leaks of claim 1, wherein said plurality of ball bearings comprises ceramic material.

9. The device for preventing leaks of claim 1, wherein said plurality of ball bearings are equally spaced apart about an inner circumference of said inner lower portion.

10. The device for preventing leaks of claim 1, wherein said plurality of O-rings comprises at least 2 of said O-rings.

11. The device for preventing leaks of claim 1, wherein a top-portion-diameter of said sleeve is greater than an outer-lower-portion-diameter of said cylindrical body.

12. The device for preventing leaks of claim 1, wherein a bottom-portion-diameter of said sleeve is greater than an outer-lower-portion-diameter of said cylindrical body.

13. The device for preventing leaks of claim 1, wherein said sleeve includes a middle portion integrally connected to a top portion and a bottom portion.

14. The device for preventing leaks of claim 13, wherein said top portion of said sleeve has a rough textured surface.

15. The device for preventing leaks of claim 13, wherein said bottom portion of said sleeve has a rough textured surface.

16. The device for preventing leaks of claim 13, wherein said middle portion of said sleeve has a smooth textured surface.

17. The device for preventing leaks of claim 13 comprising:
a cylindrical body having a top end and a bottom end;
a spring, said spring being biased within a hollow portion of said cylindrical body;
a plurality of ball bearings, said plurality of ball bearings located on an inner lower portion of said cylindrical body;
a plurality of O-rings, said plurality of O-rings being removably located within said hollow portion of said cylindrical body;
a sleeve, said sleeve being movably coupled to said cylindrical body;
wherein said device is configured to prevent leakage from a pressurized valve;
wherein said cylindrical body has an outer-upper-portion and an outer-lower-portion;
wherein said outer-upper-portion has an outer-upper-portion-diameter larger than an outer-lower-portion-diameter;
wherein said outer-upper-portion has a hexagonal shape;
wherein said outer-upper-portion is configured to provide a gripping means;
wherein said plurality of ball bearings comprise at least 2 of said ball bearings;
wherein said plurality of ball bearings is made of an aluminum material;
wherein said plurality of ball bearings are equally spaced apart about an inner circumference of said inner lower portion;
wherein said plurality of O-rings comprises at least 2 of said O-rings;
wherein a top-portion-diameter of said sleeve is greater than an outer-lower-portion-diameter of said cylindrical body;
wherein a bottom-portion-diameter of said sleeve is greater than said outer-lower-portion-diameter of said cylindrical body;
wherein said sleeve includes a middle portion integrally connected to a top portion and a bottom portion;
wherein said top portion of said sleeve has a rough texture;
wherein said bottom portion of said sleeve has a rough texture; and
wherein said middle portion of said sleeve has a smooth texture.
